(19) United States
(12) Patent Application Publication
(10) Pub. No.: US 2016/0364967 A1
(43) Pub. Date: Dec. 15, 2016

(54) PRIVACY SENSITIVE SURVEILLANCE APPARATUS

(71) Applicants: John Philippe Legg, Houston, TX (US); Luis Enrique Hernandez, Houston, TX (US)

(72) Inventors: John Philippe Legg, Houston, TX (US); Luis Enrique Hernandez, Houston, TX (US)

(21) Appl. No.: 14/737,357

(22) Filed: Jun. 11, 2015

(51) Int. Cl. G08B 13/196; G01J 5/10; H04N 5/33; G01J 5/00

(52) U.S. Cl. CPC G08B 13/19695; G01J 5/0025; G01J 5/10; H04N 5/33; G01J 2005/0077

(57) ABSTRACT

A privacy sensitive surveillance apparatus for monitoring, detecting, and displaying thermal energy is disclosed. The privacy sensitive surveillance apparatus provides for verification of the presence of thermal energy in response to an external stimulus.

### BACKGROUND OF THE INVENTION

Field of the Invention

This invention relates to surveillance and more particularly relates to a privacy sensitive surveillance apparatus for monitoring and detecting motion and thermal energy and providing a verified response in the form of a thermal image.

Description of the Related Art

Alarm systems are designed to detect and deter unwanted access into a premises. Alarm systems are set off by various triggers such as a door opening, a window opening, or motion being sensed to name a few. Law enforcement entities are summoned when an alarm system is set off Unfortunately, many times when an alarm system is set off it is a false alarm; that is, there is not an instance of unwanted access when the alarm system is set off False alarms may occur under many circumstances. Some of these circumstances include a storm or high wind shaking a door or window where the alarm's contacts are configured, dirty or poorly calibrated sensors, wireless interference, or power interruptions.

False alarms account for a high percentage of all alarm responses. The rate of false alarms is so high that a growing number of law enforcement entities require the alarm system monitoring company to verify that the premises has in fact been breached by an intruder before the law enforcement entity will dispatch a unit. This verification process is tedious, costly and sometimes does not produce a reliable response.

In order to produce a verified response, alarm system monitoring companies will often use telephone communication and dial the phone number on file to verify with the intended recipient whether the premises should have activity. If the intended recipient is in the premises when the phone call is answered, then an accurate verified response can be given. If the intended recipient is not in the premises when the phone call is answered, then the verified response loses reliability since a first-hand account of the premises is not available. For a verified response to be reliable, a visual of the interior of the premises must be achieved. While clear surveillance apparatuses are available, such visual clarity is not always desirable within environments where there is a high expectation of privacy.

From the foregoing discussion, it should be apparent that a need exists for a privacy sensitive surveillance apparatus that monitors, detects, and displays motion and thermal energy. Beneficially, the surveillance of such an apparatus would show that there is a heat signature in a premises after an alarm system is set off.

### SUMMARY OF THE INVENTION

The present invention has been developed in response to the present state of the art, and in particular, in response to the problems and needs in the art that have not yet been fully solved by currently available surveillance apparatuses. Accordingly, the present invention has been developed to provide a privacy sensitive surveillance apparatus that overcomes many or all of the above-discussed shortcomings in the art. In one embodiment, the present invention transmits a digital image of thermal energy in response to motion being sensed. The present invention may operate in environments sensitive to privacy and, as such, may transmit a low resolution thermal image to protect privacy.

The privacy sensitive surveillance apparatus, in one embodiment, is configured with a passive infrared motion sensor. The motion sensor may be configured to measure infrared light.

The apparatus is further configured, in one embodiment, with a low resolution thermal imager for detecting thermal energy. The low resolution thermal imager may be configured to process the detected thermal energy using a two-dimensional sensor with an array size that has a width of no more than eighty pixels and a height of no more than eighty pixels.

The apparatus may be configured with a first communication link that is configured between the motion sensor and the low resolution thermal imager. In one embodiment, the motion sensor is configured to transmit a signal to the low resolution thermal imager using the first communication link. The signal may activate the low resolution thermal imager. In one embodiment, the signal deactivates the low resolution thermal imager.

In a further embodiment, the apparatus includes a communication module that is configured to receive and transmit data over a communications network. The communication module may be configured to connect to the communications network with a wired data connection. In another embodiment, the communication module is configured to connect to the communications network with a wireless data connection.

In one embodiment, the communication module transmits data to and receives data from an alarm system through the communications network. In another embodiment, the communication module transmits data to and receives data from a cellular device through the communications network. The communication module may transmit data to and receive data from an alarm system monitoring company.

In one embodiment, the apparatus has a second communication link between the motion sensor and the communication module. The motion sensor may transmit data through the second communication link to the communication module. In one embodiment, the motion sensor receives data through the second communication link.

The apparatus may include a third communication link that is configured between the low resolution thermal imager and the communication module. In one embodiment, the low resolution thermal imager transmits data through the third communication link to the communication module.

In one embodiment, the apparatus includes a power module. The power module may be configured to connect to one or more power sources. One power source may be used as a primary power source and other power sources may be used as secondary, or backup, power sources. In one embodiment, the primary power source is an alternating current power source. In one embodiment, the secondary power source is a direct current power source.

References throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a privacy sensitive surveillance apparatus in accordance with the present invention;

FIG. 2 is a front view depiction of a housing of a motion sensor and low resolution thermal imager in accordance with the present invention;

FIG. 3 is a rear view depiction of a housing of a power source interface and a communications network interface in accordance with the present invention;

FIG. 4 is a rear view depiction of a housing of a primary power source interface, a secondary power source interface, and a communications network interface in accordance with the present invention;

FIG. 5 is a depiction of a low resolution thermal image in accordance with the present invention; and

FIG. 6 is a depiction of a low resolution thermal image in accordance with the present invention.

### DETAILED DESCRIPTION OF THE INVENTION

References throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize that the invention may be practiced without one or more of the specific details, or with other components, materials, and so forth. In other instances, well-known structures, materials, or operations are not shown or described in detail to avoid obscuring aspects of the invention.

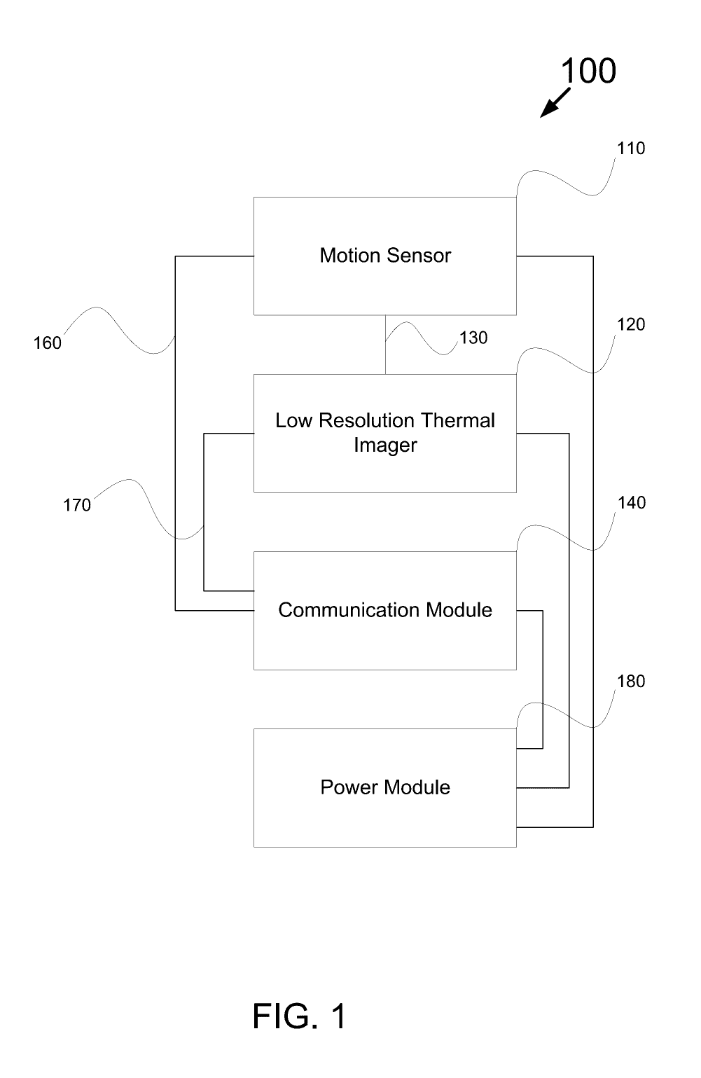

FIG. 1 depicts a schematic block diagram illustrating one embodiment of a privacy sensitive surveillance apparatus in accordance with the present invention. The depicted privacy sensitive surveillance apparatus 100 includes a motion sensor 110, a low resolution thermal imager 120, a first communication link 130, a communication module 140, a second communication link 160, a third communication link 170, and a power module 180. The depicted apparatus 100 is one example of a privacy sensitive surveillance apparatus for providing verification of a heat signature in response to an external stimulus in accordance with the present invention.

The motion sensor 110 may be a passive infrared sensor. In one embodiment, the motion sensor 110 measures infrared light radiating in its field of view. The motion sensor 110 may detect motion by measuring infrared light.

The low resolution thermal imager 120 may detect thermal energy. The low resolution thermal imager 120 may detect subtle thermal energy differences of everything in its field of view. The low resolution thermal imager 120 may process the subtle differences in thermal energy into a digital image using a two-dimensional sensor that has an array size with a maximum resolution width of eighty pixels and a maximum resolution height of eighty pixels. The low resolution thermal imager 120 may produce a digital video using two or more consecutive digital images.

In one embodiment, the first communication link 130 is between the motion sensor 110 and the low resolution thermal imager 120. The first communication link 130 may provide a pathway for communication between the motion sensor 110 and the low resolution thermal imager 120. In one embodiment, the motion sensor 110 communicates with the low resolution thermal imager 120.

The motion sensor 110 may transmit a signal to the low resolution thermal imager 120 over the first communication link 130 to activate or deactivate the low resolution thermal imager 120. The low resolution thermal imager 120 may be activated and deactivated.

In one embodiment, the communication module 140 connects to a communications network. The communication module 140 may receive data from and transmit data to the communication network. In one embodiment, the communication module 140 connects to the communication network via a wired interface. In one embodiment, the communication module 140 connects wirelessly to the communications network.

The second communication link 160 may be between the motion sensor 110 and the communication module 140. The motion sensor 110 may transmit data to the communication module 140 over the second communication link 160.

In one embodiment, the third communication link 170 is between the low resolution thermal imager 120 and the communication module 140. The low resolution thermal imager 120 may transmit data to the communication module 140 over the third communication link 170. In one embodiment, the low resolution thermal imager 120 transmits digital images of thermal energy detected in its field of view. The low resolution thermal imager 120 may transmit digital videos displaying the thermal energy detected in its field of view.

The power module 180 may supply and distribute power to the privacy sensitive surveillance apparatus 100. In one embodiment, the power module 180 is connected to an alternating current power source. In one embodiment, the power module 180 is connected to a direct current power source. The power module 180 may be connected to both an alternating current power source and a direct current power source in which case it may use the alternating current power source as a primary power source and the direct current power source as a secondary power source.

The depicted apparatus 100 may communicate with computer systems and electronic devices such as an alarm system, an alarm system monitoring company's computer system, and a cellular device. In one embodiment the communication module 140 connects to the same communications network as an alarm system. The communication module 140 may receive data from the alarm system. In one embodiment, the communication module 140 transmits data to the alarm system. The motion sensor 110, upon detecting motion by measuring infrared light, may send a signal over the first communication link 130 to activate the low resolution thermal imager 120. In one embodiment, the motion sensor 110 transmits data to the alarm system via the second communication link 160 and the communication module 140.

In one embodiment the communication module 140 connects to the same communications network as a cellular device. The communication module 140 may receive data from the cellular device. In one embodiment, the communication module 140 transmits data to the cellular device. Data transmitted to the cellular device may include digital images generated by the low resolution thermal imager 120. The communication module 140 may receive data from the cellular device. In one embodiment, the motion sensor 110 receives data from the cellular device toggle on and off. The low resolution thermal imager 120 may receive data from the cellular device to toggle on and off.

In one embodiment the communication module 140 is configured to connect to the same communications network as an alarm system monitoring company's computer system. The communication module 140 may be configured to receive data from the alarm system monitoring company's computer system. In one embodiment, the communication module 140 is configured to transmit data to the alarm system monitoring company's computer system. Data transmitted to the alarm system monitoring company's computer system may include digital images generated by the low resolution thermal imager 120. The communication module 140 may be configured to receive data from the alarm system monitoring company's computer system. In one embodiment, the motion sensor 110 receives data from the alarm system monitoring company's computer system to toggle on and off. The low resolution thermal imager 120, may receive data from the alarm system monitoring company's computer system to toggle on and off

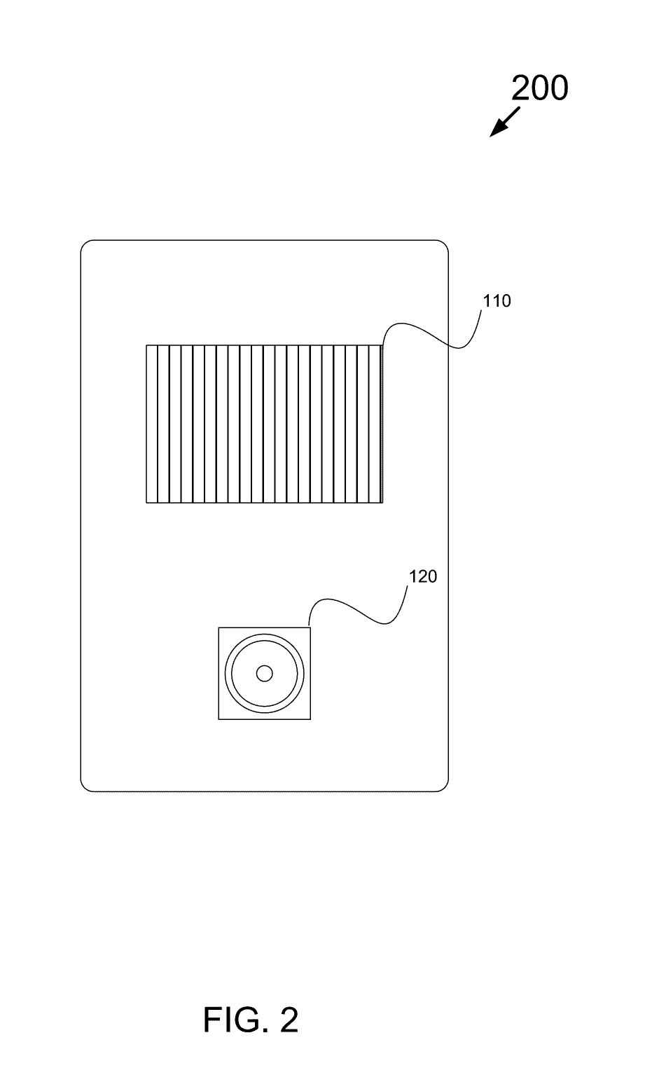

FIG. 2 depicts a front view of a housing of a privacy sensitive surveillance apparatus showing a motion sensor 110 and a low resolution thermal imager 120 in accordance with the present invention. The depicted apparatus 100 is one example of a privacy sensitive surveillance apparatus for providing verification of a heat signature in response to an external stimulus in accordance with the present invention.

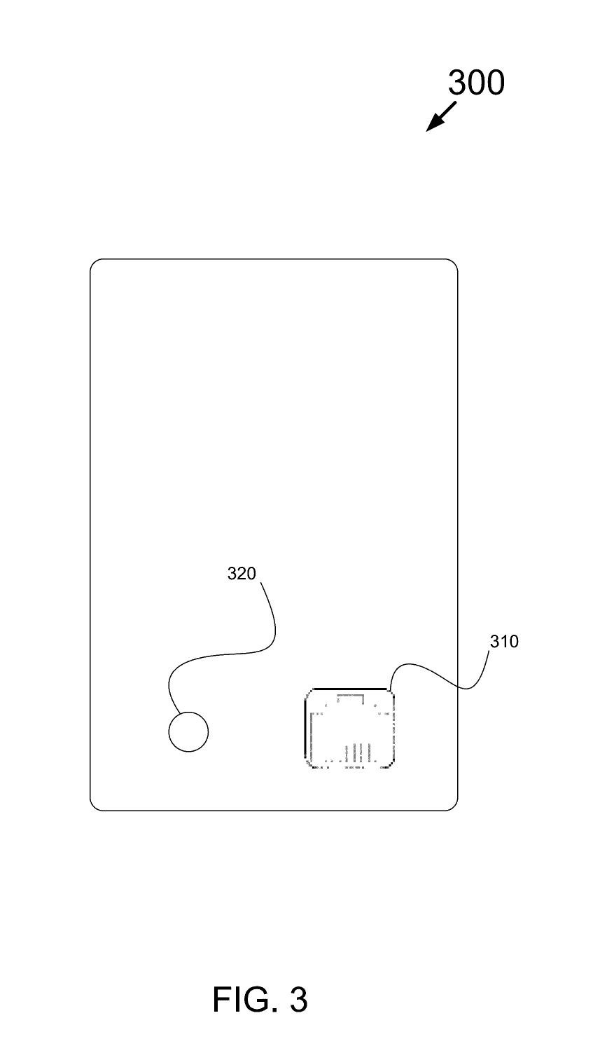

FIG. 3 depicts a rear view of a housing of a privacy sensitive surveillance apparatus in accordance with the present invention. The depicted privacy sensitive surveillance apparatus 300 shows a communications network interface 310 and an alternating current power source interface 320. The depicted apparatus 300 is one example of a privacy sensitive surveillance apparatus capable of providing verification of a heat signature in response to an external stimulus in accordance with the present invention.

The communications network interface 310 may accept a network attached cable connecting the communications module 140 to a communications network. The alternating current power source interface 320 may accept a connection to an alternating current power source connecting the power module 180 to the power source.

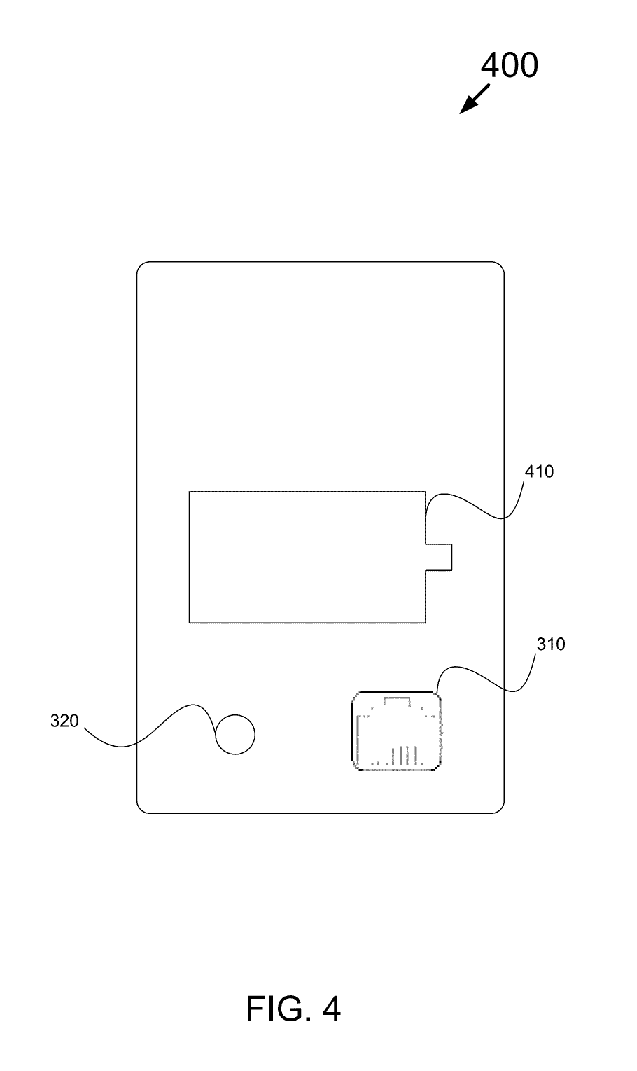

FIG. 4 depicts a rear view of a housing of a privacy sensitive surveillance apparatus in accordance with the present invention. The depicted privacy sensitive surveillance apparatus 400 shows a communications network interface 310, an alternating current power source interface 320, and a direct current power receptacle 410. The depicted apparatus 400 is one example of a privacy sensitive surveillance apparatus capable of providing verification of a heat signature in response to an external stimulus in accordance with the present invention.

The direct current power receptacle 410 may accept a direct current power source. The direct current power source may be a battery. In one embodiment, the direct current power source is rechargeable. The direct current power receptacle 410 may recharge the direct current power source using power from an alternating current power source connected to the alternating current power source interface 320.

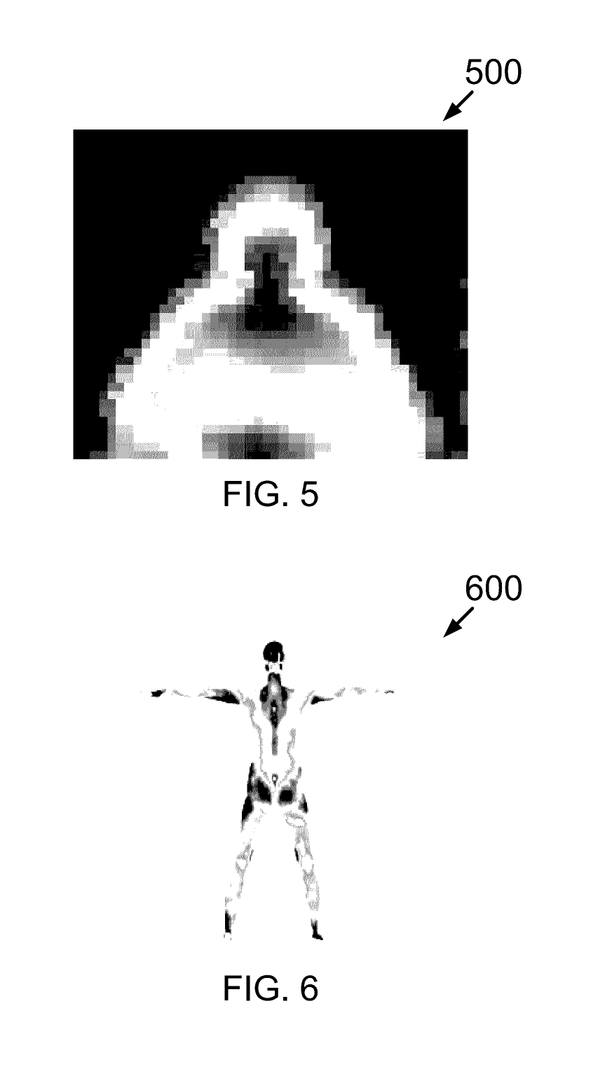

FIG. 5 is a depiction of a low resolution thermal image in accordance with the present invention. The low resolution thermal image 500 depicts the display of subtle differences of thermal energy of a human's upper region. In one embodiment, the low resolution thermal image 500 leaves privacy intact by not showing distinct features or clear, personal attributes of a subject. The low resolution thermal image 500 does not show detailed traits of the subject so it protects the subject's privacy; however, it clearly provides verification that the source of the thermal energy is human. The resolution of the low resolution thermal image 500 may be no more than eighty pixels in height and no more than eighty pixels in width.

FIG. 6 is a depiction of a low resolution thermal image in accordance with the present invention. The low resolution thermal image 600 shows one embodiment of a display of subtle differences of thermal energy of a human. As depicted, the low resolution thermal image 500 leaves privacy intact. The low resolution thermal image 500 does not show detailed traits of the subject so it protects the subject's privacy; however, it clearly identifies that the source of the thermal energy is human. The resolution of the low resolution thermal image 600 may be no more than eighty pixels in height and no more than eighty pixels in width.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A privacy sensitive surveillance apparatus, the apparatus comprising:
a motion sensor configured with a passive infrared sensor;
the motion sensor further configured to measure infrared light;
a low resolution thermal imager configured to detect thermal energy;
the low resolution thermal imager further configured to process detected thermal energy into a digital image using a two-dimensional sensor with an array size that has a maximum width of eighty pixels and a maximum height of eighty pixels;
a first communication link configured between the motion sensor and the low resolution thermal imager;
the motion sensor configured to transmit a signal to the low resolution thermal imager via the first communication link;
a communication module configured to receive and transmit data over a communications network;
a second communication link, wherein the second communication link is configured between the motion sensor and the communication module;
the motion sensor further configured to transmit data through the second communication link;
a third communication link, wherein the third communication link is configured between the low resolution thermal imager and the communication module;
the low resolution thermal imager further configured to transmit data through the third communication link to the communication module; and
a power module configured to connect to at least one power source, wherein one power source is a primary power source and other power sources are secondary power sources.

2. The apparatus of claim 1, wherein the communication module is further configured to connect to the communications network with a wired data connection.

3. The apparatus of claim 1, wherein the communication module is further configured to connect to the communications network with a wireless data connection.

4. The apparatus of claim 1, wherein the low resolution thermal imager is further configured to receive data from the communications module via the third communication link.

5. The apparatus of claim 1, wherein the communication module is further configured to transmit data to and receive data from an alarm system through the communications network.

6. The apparatus of claim 1, wherein the communication module is further configured to transmit data to and receive data from a cellular device through the communications network.

7. The apparatus of claim 1, wherein the communication module is further configured to transmit data to and receive data from an alarm system monitoring company through the communications network.

8. The apparatus of claim 1, wherein the motion sensor is further configured to receive data over the second communication link.

9. The apparatus of claim 1, wherein the power module is further configured to receive power from an alternating current power source.

10. The apparatus of claim 9, wherein the power module is further configured to use power received from the alternating current power source as the primary power source.

11. The apparatus of claim 1, wherein the power module is further configured to receive power from a direct current power source.

12. The apparatus of claim 1, wherein the signal transmitted by the motion sensor to the low resolution thermal imager activates the low resolution thermal imager.

13. The apparatus of claim 1, wherein the signal transmitted by the motion sensor to the low resolution thermal imager deactivates the low resolution thermal imager.
